(19) United States
(12) Patent Application Publication
(10) Pub. No.: US 2017/0109815 A1
(43) Pub. Date: Apr. 20, 2017

(54) ON DEMAND AUCTIONS OF CLOUD RESOURCES (BUNDLES) IN HYBRID CLOUD ENVIRONMENTS

(71) Applicant: International Business Machines Corporation, Armonk, NY (US)

(72) Inventors: Kun Bai, Hartsdale, NY (US); Yun-Wu Huang, Chappaqua, NY (US); Jinho Hwang, Ossining, NY (US); Clifford A. Pickover, Yorktown Heights, NY (US); Maja Vukovic, New York, NY (US); Christopher C. Young, Sleepy Hollow, NY (US)

(21) Appl. No.: 14/885,339

(22) Filed: Oct. 16, 2015

(51) Int. Cl. G06Q 30/08; H04L 29/08; H04L 12/24

(52) U.S. Cl. CPC G06Q 30/08; H04L 41/5029; H04L 67/10

(57) ABSTRACT

Embodiments of the present invention disclose a method, computer program product, and system for performing auctions of cloud based resources. A plurality of requests for a set of cloud based resources are received. A set of preferences associated with the received plurality of requests are received. Data is received that is associated with the set of cloud based resources. The data includes an index of available resources, a cost value associated with one or more available resources of the available resources, and a rate of consumption value of available resources of the available resources. An auction technique is established for matching a subset of cloud based resources within the set of cloud based resources and an associated request of the plurality of requests. A match is determined between a subset of cloud based resources and a received request, the match is the output of the established auction technique.

### BACKGROUND

The present invention relates generally to the field of computing resources, and more particularly to managing cloud resources.

Development in Cloud computing has enabled the business to being delivering computing as a utility. For example, cloud services may be offered on a “pay as you go” basis. Providing cloud services has changed to provide a market infrastructure in the form of a Market Exchange (ME) that facilitates the trading between consumers and Cloud providers. Such a market environment eases the trading process by aggregating IT services from a variety of sources, and allows consumers to select them.

As competition for cloud resources increase, consumers of Cloud services may look to reduce costs my engaging in multiple Cloud recourses. Engaging with and trading with multiple cloud resource services providers may be costly or time prohibitive leaving consumers with only one cloud resource provider, which may be insufficient.

### SUMMARY

The potential for consumers to utilize resources from different cloud resource providers to fulfill their requirements may be more cost effective, than traditional techniques. Embodiments of the present invention disclose a method, computer program product, and system for performing auctions of cloud based resources. In various embodiments, a plurality of requests are received, wherein the request is for a set of cloud based resources. A set of preferences are received, wherein the preferences are associated with the received plurality of requests. Data is received that is associated with the set of cloud based resources. The data includes an index of available resources, a cost value associated with one or more available resources of the index of available resources, and a rate of consumption value of available resources of the index of available resources. An auction technique is established for matching a subset of cloud based resources within the set of cloud based resources and an associated request of the plurality of requests. A match is determined between a subset of cloud based resources and a received request, based on the received preferences and received data, wherein the match is the output of the established auction technique.

### BRIEF DESCRIPTION OF THE SEVERAL VIEWS OF THE DRAWINGS

The following detailed description, given by way of example and not intended to limit the invention solely thereto, will best be appreciated in conjunction with the accompanying drawings, in which:

FIG. 1 is a functional block diagram illustrating a distributed data processing environment, in accordance with an embodiment of the present invention.

FIG. 2 functional block diagram illustrating the components of an auction application running on a server computer, within the data processing environment of FIG. 1, in accordance with an embodiment of the present invention.

FIG. 3 is a flowchart depicting operational steps of an auction program, on a server computer within the data processing environment of FIG. 1, for receiving and fulfilling requests for Cloud resources, in accordance with an embodiment of the present invention.

FIG. 4 depicts a block diagram of components of computing devices within the distributed data processing environment, in accordance with an embodiment of the present invention.

FIG. 5 is a schematic block diagram of an illustrative cloud computing environment, according to an aspect of the present invention.

FIG. 6 is a multi-layered functional illustration of the cloud computing environment of FIG. 5, according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions IBM Confidential; Attorney Work Product; Attorney Client Privileged by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Cloud resource consumers may increase cloud computing usage and desire workloads running in a number of different Cloud environments, offered by different providers, as described in relation to embodiments of the present invention. A Cloud broker systems can enable delivery experts to control the resources from multiple providers. Auction mechanisms can allow for monitoring of low peak times and/or cost for a given provider in order to take advantage of a lower cost for a specific set of jobs.

It would be advantageous to provide a method and system for automatically negotiating with multiple providers to dynamically and optimally reallocate and distribute the workloads. Multi-attribute auctions can provide a buyer with the ability to retain flexibility during negotiation, in which a requests may express several alternative requests such that different combinations of resources may be requested, without making an up-front commitment to a particular combination of attributes.

A multi-attribute auction may be utilized in order to facilitate the exchange of offers to engage with Cloud resource providers, expressed through bids, and the resulting computational problem of determining an optimal set of resources or trades for a particular bid or set of bids. A multi-attribute auction is a market-based mechanism where goods are described by vectors of features, or. Such mechanisms provide traders with the ability to negotiate over a multidimensional space of potential deals, delaying commitment to specific configurations until the most promising candidates are identified. For example, in a multi-attribute auction for computers, the good may be defined by attributes, or computer resources, such as processor speed, memory, and hard disk capacity. Agents have varying preferences (or costs) associated with the possible configurations. For example, a buyer may be willing to purchase a computer with a 2 GHz processor, 500 MB of memory, and a 50 GB hard disk for a price no greater than $500, or the same computer with 1 GB of memory for a price no greater than $600.

The distinguishing feature of a multi-attribute auction, as defined in Engel, et al. “Bid Expressiveness and Clearing Algorithms in Multiattribute Double Auctions”, EC '06 Proceedings of the 7th ACM conference on Electronic commerce, pgs 110-119, is that the properties of cloud based resources can be defined by vectors of attributes or resources, x=(xₗ, . . . , xₘ), for example agility, API availability, cost, accessibility, maintenance, productivity, reliability, scalability, or security. A configuration is a particular attribute vector, x, where x=Πᵢ₌₁^{m} Xⱼ. Where x belongs to the set of attributes X. The outcome of the auction is a set of bilateral trades. Trades, t, can be defines as t=(x,q,b,s,π), where an agent, b, buys units, q, where q>0, of configuration x from seller, s, for payment, π, where π>0. For a set of trades T, we denote by Ti which is a subset of T involving an agent, i (i.e., b=i or s=i). Let T denote the set of all possible trades. Let O^{t}ᵢ denote agent i's trade offer set which is a of all Tᵢ).

An agent's offer trade set implicitly defines the agent's willingness to pay for any given configuration and quantity. An agent's willingness to pay for a quantity q of configuration of attributes, x, may be given by ûᵢ^{B}(x,q)=max π s.t.(x,q,i,*,π)∈Oᵢ^{T}.

The symbol û is used to recognize that willingness to pay can be viewed as a proxy for the agent's utility function, measured in monetary units. The superscript B distinguishes the buyer's willingness to-pay function. Agent i's minimum trade quantity for configuration x is given by qᵢ(x)=min q s.t. [symbol] π. (x,q,i,*,π)∈Oᵢ^{T}; an agent i's maximum quantity for configuration x is given by

q̅ᵢ̅(x)=max q s.t.

[symbol]

π. (x,q,i,*,π)∈Oᵢ^{T} [symbol] q′<q.(x,q′,i,*,π)∈Oᵢ^{T}

A Trade surplus can be given by σ(t)=û_{b}^{B}(x,q)−ûₛ^{S}(x,q), where the trade surplus does not depend on the payment, which is simple a transfer from buyer to seller.

The Global Multiattribute Allocation Problem (GMAP) is to find the set of acceptable trades maximizing total surplus is given by

$${max}_{T ∈ {2}^{T}} {\sum }_{t ∈ T} σ ( t ; T \backslash \{ t \} ) s . t . ∀ i . {T}_{i} ɛ {O}_{i}^{C}$$

The Multi-attribute Matching Problem (MMP) is to find a best trade for a given pair of traders

$$MMP ( b , s ) = arg {max}_{t ∈ {O}_{b}^{T} ⋂ {O}_{δ}^{T}} σ ( t ) ,$$

where if t∈O_{b}^{T} ∩ O_{δ}^{T} is empty, the MMP may be describes as having no solution.

The above described multi-attribute auction implementation may be utilized to optimize and English, Dutch, or Vickrey auctions. It should be appreciated that the above equations are merely an example of one possible implementation of multi-attribute auctions and other implementations, equations, and algorithms may be used. An English auction allows a starting price or reserve for resources and the system may accept increasing bids from consumers. The bids in an English auction may be open or fully transparent as the identity of all bidders are disclosed to all bidders. A Dutch auction may adjust the cost of a resource in a direction that favored the bidders where the system may lower the price of resources to competing buyers, or increasing the price of resources, if it is a reverse auction. A Vickrey auction is a type of sealed-bid auction where bidders submit bids without knowing the bid(s) of the others in the auction. The highest bidder wins the auction and receives the bid for resources but only pays the cost of the second-highest bid.

In various embodiments of the present invention, consumers of Cloud resources may access a multi-attribute auction, described above, and request multiple Cloud providers to perform multiple jobs. The Cloud providers may dynamically assign or reassign workloads that may optimize cost and quality of job execution.

In various embodiments of the present invention, a trans-vendor service, that may be an Infrastructure as a service (IaaS), Platform as a service (PaaS), or Software as a service (SaaS), performs an auction of cloud based resources, which may be offered by multiple providers. The service may receive a request for a set of cloud resources and preferences associated with that request, for example, a list of jobs that need to be performed by the resources, the priority of the jobs, and execution deadlines. The service may obtain descriptions of available resources from the cloud based resource providers, along with the current price and demand of said resources. An auction technique may be established by the system to optimize the execution of selected jobs across multiple cloud based resource providers.

In various embodiments, cloud based resources may include computational resources, storage resources, or network resources. The system may process requests using natural language processing. When establishing an auction technique and obtaining an optimal cloud based resource for the request, levels of “risk” may be implemented to determine the optimal cloud based resource for the request. In various embodiments risk levels may be predetermined for various attributes of a cloud based resource.

In various embodiments the established auction technique may be an English auction, which may have open ascending prices, a Dutch auction, which may have open descending prices, a Vickrey auction, which may have sealed-bid second-prices, a sealed bid first-price auction (blind auction), or a multiunit auction that sells more than one identical resource at a time, as opposed to one cloud based resource having a separate auction. The cloud based resources may be a Private cloud, Public cloud, Hybrid cloud, Community cloud that shares infrastructure between several organizations from a specific community with common concerns, Distributed cloud that is a set of machines running at different locations while still connected to a single network or hub service, Intercloud which is an interconnected global “cloud of clouds” and an extension of the Internet “network of networks,” on which it is based, or a Multicloud that contains multiple cloud computing services in a single heterogeneous architecture in order to reduce reliance on any single vendor.

In various embodiments, when establishing a match between a request and a cloud based resource in an auction, the system may take into account attributes of the cloud based resource, including: agility, meaning features that improve users' ability to re-provision technological infrastructure resources; available application programming interfaces (APIs); cost; device and location independence, meaning features that enable users to access systems using a web browser regardless of their location or what device they use; maintenance; multitenancy features that enable sharing of resources; performance; productivity that may be increased when multiple users can work on the same data simultaneously; reliability that may improve with the use of multiple redundant sites, which makes well-designed cloud computing suitable for business continuity and disaster recovery; scalability and elasticity via dynamic “on-demand” provisioning of resources on a fine-grained, self-service basis in near real-time; and/or security of centralized data.

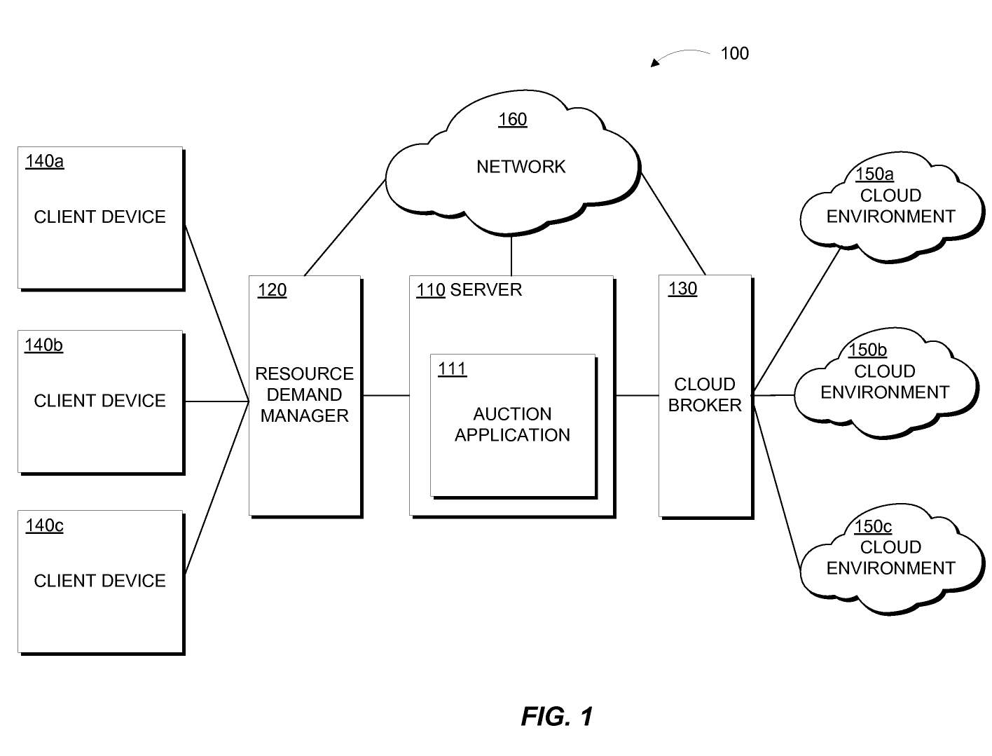

Embodiments of the present invention will be described with reference to the Figures. Referring to FIG. 1, FIG. 1 is a functional block diagram illustrating a computer system for Cloud resource distribution auctions within distributed data processing environment 100, in accordance with an embodiment of the present invention. Distributed data processing environment 100 includes server 110, resource demand manager 120, cloud broker 130, client devices 140, and cloud environments 150, all interconnected via network 160.

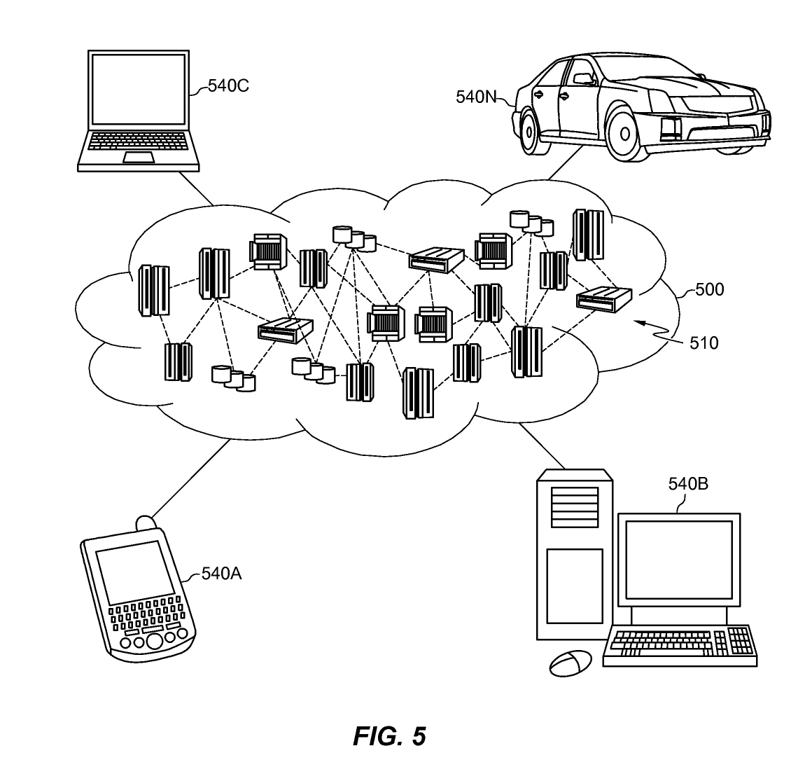

Network 160 may include permanent connections, such as wire or fiber optic cables, or temporary connections made through telephone or wireless communications. Network 160 may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Network 160 may also include a number of different types of networks, such as, for example, an intranet, a local area network (LAN), or a wide area network (WAN). Network 160 may also include a cloud computing environment, for example, cloud computing environment 500 of FIG. 5.

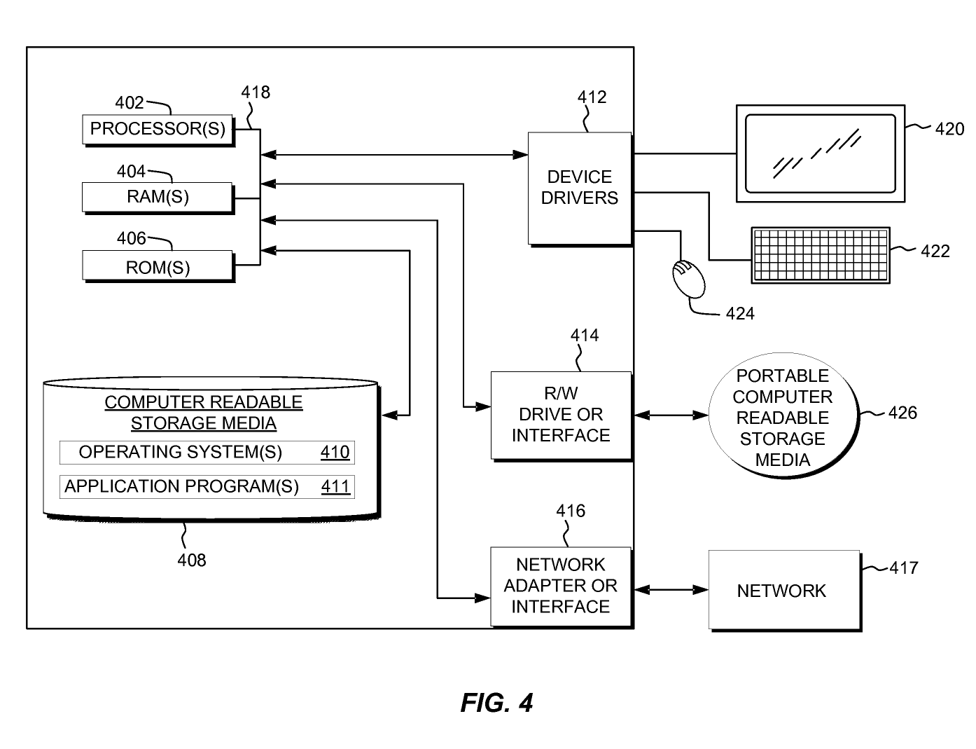

Each of server 110, resource demand manager 120, cloud broker 130, and client devices 140 may be a laptop computer, tablet computer, netbook computer, personal computer (PC), desktop computer, smart phone, or any programmable electronic device capable of an exchange of data packets with other electronic devices, for example, through a network adapter, in accordance with an embodiment of the invention, and which may be described generally with respect to FIG. 4 below. In various embodiments, server 110 may be a separate server or series of servers, a database, or other data storage, internal or external to resource demand manager 120, cloud broker 130, and client devices 140.

Client devices 140 may act generally to receive input from a user, receive job requirements, communicate resource request queries to resource demand manager 120 over network 160, and receive query from resource demand manager 120.

Client devices 140 may receive input from a user, or Cloud resource consumer, display data in a graphical user interface, or GUI, or communicate over a network 160, via an application window or web browser. Client devices 140 may receive a Cloud resource request input from a user. The request query may include a request for available Cloud environments, preferences for a Cloud environment, and/or past, current, or projected Cloud environment prices. Client devices 140 may communicate received queries to resource demand manager 120. In response to receiving results from a resource request query, client devices 140 may communicate a bid for resources to resource demand manager 120.

It may be appreciated by those in the art that Client devices 140 may also be Cloud environment providers. Cloud providers may participate in this trans-vendor service, as they may be able to attract more users and remuneration by participating in the service, in contrast to not participating.

Resource demand manager 120 may act generally to receive resource requests, for example, from client devices 140, receive Cloud environment data, for example from Cloud environments 150 via server 110, and communicate resource requests to server 110 via network 160. Resource demand manager 120 may receive a plurality of resource requests from a plurality of client devices, for example, client device 140a, client device 140b, client device 140c, . . . client device 140n. Client device 140n is not shown and may be appreciated as merely a representation of client devices of any number communicating resource requests to resource demand manager 120.

Resource demand manager 120 may index and store received resource requests may be stored as entries into a data store or queue that may be, for example, a FIFO queue, LIFO queue, circular queue, or any other data structure. Resource demand manager 120 may receive bids for resources from client devices 140. In various embodiments, resource demand manager 120 may index bids and store bids in a data store with the associated request, such that, the bids and resource requests are collated, for example, by owner. Resource demand manager 120 may communicate resource requests and bids to server 110 via network 160.

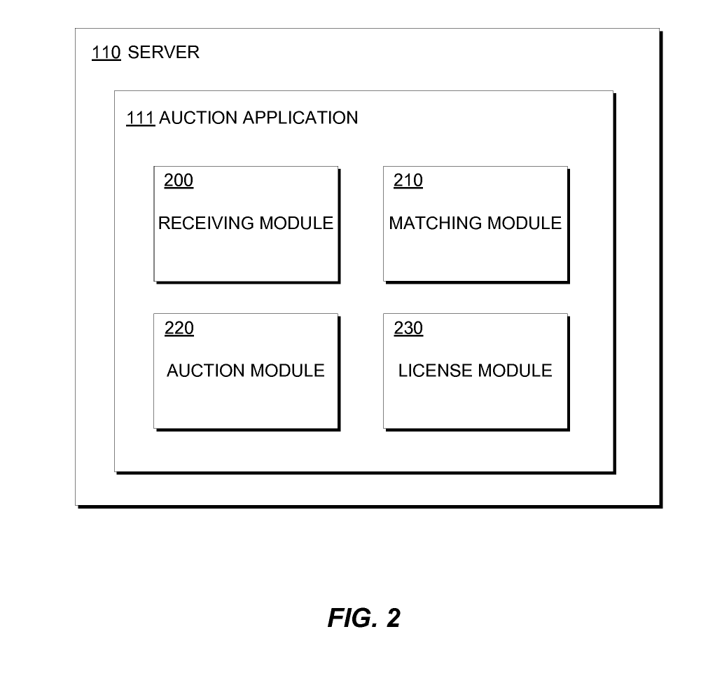

Server 110 includes, auction application 111, as described in greater detail in reference to FIG. 2. In various embodiments, server 110 operates generally to receive resource request queries or resource requests, Cloud environment data, resource bids, communicate received data, and host applications, for example, auction application 111, which may process and/or store data.

Auction application 111 may be, for example, database oriented, computation oriented, or a combination of these. Auction application may operate generally to receive requests for a set of cloud resources, receive bids for cloud resources, receive Cloud environment data, for example, bandwidth, price, and/or current demand, establish an auction technique to match resource bids and Cloud environments or optimize the execution of requests across multiple Cloud providers. Auction application may establish an auction technique, for example, an English auction (open ascending price auction, which is arguably the most common form of auction in use today), Dutch auction (open descending price auction), sealed first-price auction or blind auction, or Vickrey auction (sealed-bid second-price auction), multiunit auctions (sell more than one identical item at the same time, rather than having separate auctions for each).

In various embodiments, in order to match received resource bids to cloud environments (winning bid), auction application 111 may analyze the agility, cost, device location, maintenance status, productivity capability, reliability, or scalability of the Cloud environments auction application 111 is monitoring, for example cloud environments 150. It may be appreciated that the former list of features is merely exemplary and extra features may be analyzed and used to match received bids and cloud environments, via received cloud environment data. In various embodiments of the invention the cloud environment data is received via cloud broker 130.

Cloud broker 130 may operate generally to receive queries from auction application 111 via server 110 for cloud environment data, receive cloud environment data from a Cloud computing network, for example cloud environments 150, and communicate received cloud environment data to auction application 111 via server 110.

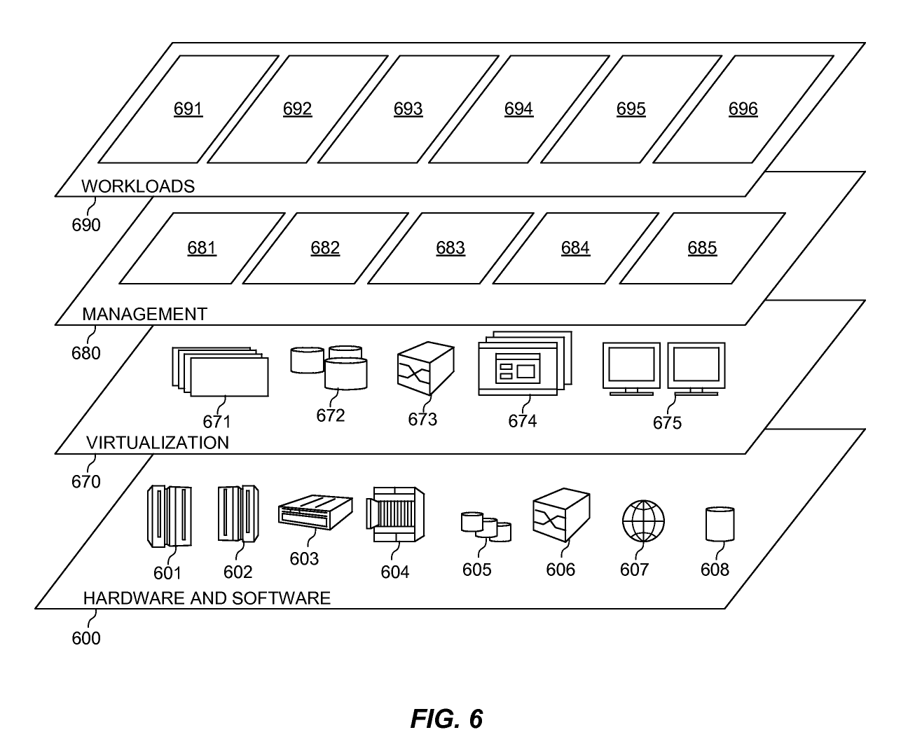

Cloud environments 150 may be various cloud environments as described in reference to FIGS. 5 and 6 below. It should be appreciated by those in the art that cloud environments 150 may be a Private cloud, Public cloud, Hybrid cloud, Community cloud that shares infrastructure between several organizations from a specific community with common concerns, Distributed cloud which is a distributed set of machines that are running at different locations, while still connected to a single network or hub service, Intercloud or an interconnected global “cloud of clouds” based on the Internet “network of networks”, or Multicloud which is multiple cloud computing services in a single heterogeneous architecture. It should also be appreciated that cloud environments 150 represent merely an exemplary number of cloud based environments.

In various embodiments, cloud environments 150 may represent a plurality of cloud environments, for example, cloud environment 150a, cloud environment 150b, cloud environment 150c, . . . cloud environment 150n. Cloud environment 150n is not shown and may be appreciated as merely a representation of cloud environments of any number communicating resource data and access to cloud broker 130. This flexibility in cloud environment may reduce the reliance on any single vendor and may increase flexibility through choice, which may increase uptime and security.

Referring to FIG. 2, FIG. 2 is a functional block diagram illustrating the components of an auction application 111 running on a server computer, within the data processing environment of FIG. 1, in accordance with an embodiment of the present invention. Auction application 111 includes receiving module 200, matching module 210, auction module 220, and license module 230.

In reference to FIGS. 1 and 2, a system according to an embodiment of the present invention includes a receiving module 200 which may act generally to receive a query or set of queries, receive cloud environment data, receive input from a user, and/or communicate with computing devices in distributed data processing environment 100 via server 110. In various embodiments receiving module 200 may receive a resource request from a client, for example, client device 140a, receive cloud environment data from a provider, for example, cloud environment 150a, receive a resource bid via client device 140a, and communicate matching bids and cloud environment notices received from auction module 220, described in more detail below.

In various embodiments, client devices 140 and cloud environments 150 may be part of the Cognitive Computing (CC) market. Receiving module 200 may receive natural-language queries for access to various CC algorithms, capabilities, and databases that may be integrated into various cloud environments 150. For example, the trans-vendor auction service may enable more than one provider, for example, cloud environment 150a, to integrate an overlying Cognitive Computing service with the cloud environment for consumption by a client, for example client device 140a. Receiving module 200 may communicate received requests, bids, and cloud environment data to matching module 210.

Matching module 210 may act generally to receive resource requests and cloud environment data, analyze resource requests and cloud environment data, identify qualified cloud environments based on received cloud environment data, and communicate qualified cloud environments to auction module 220. Matching module 210 may analyze received resource requests and may identify attributes in the resource request, for example, a resource request may include specific jobs, priority, and deadlines indicating the preferred cloud environment. Matching module 210 may analyze received cloud environment data and identify the availability, cost, device location, agility, API availability, accessibility or security level for access, maintenance requiring a certain percentage of cloud downtime, productivity or speed, reliability or total uptime percentage, or scalability. Matching module 210 may identify cloud environments that are within a tolerance value of the resource requests. The tolerance value may be a predetermined value indicating the desired precision of the match and may be received with the resource requests or established at the initialization of the system. Matching module 210 may communicate identified qualified cloud environments to auction module 220 and client devices 140 via server 110.

Auction module 220 may act generally to receive qualified cloud environments, resource bids, calculate an auction style, calculate winning bid, communicate winning bid notification, and connect winning client device to cloud environment associated with winning bid.

In various embodiments, auction module 220 may receive resource bids and qualified cloud environments. Auction module 220 may receive a plurality of bids for each received qualified cloud environment. Auction module 220 may select an auction type in order to process the received bids and qualified cloud environments. Selects auction type Auction type selection may be random, predetermined or based on the solution to the Global Multiattribute Allocation Problem (GMAP), in which the best match within the auction may be based on the solution to the Multiattribute Matching Problem (MMP), both described above. In various embodiments, solving for the MMP may yield the optimal match between a resource bid and qualified cloud environment, if the solution set is not empty as described above. In various embodiments, auction module 220 may select an auction type by performing one or more auctions in parallel and selecting the auction type that yields a match, times out, or delivers the best performance may be selected.

In various embodiments auction module 220 may associate a risk level to received resource bids and qualified cloud environments. Risk levels may be identified via analysis of the attributes of the resource bid based on the resource request and the attributes of the qualified cloud environment. Risk level may enable auction module 220 to group received bids and qualified cloud environments which may increase the efficiency of the selected auction process or auction matching process. It may be appreciated that risk level may be associated with a specific attribute, for example, a cloud environment located in a certain region may be assigned a risk level 5 due to know issues in network stability associated with that region, may not be matched with a resource bids with a risk level 3 or lower requirement.

Auction module 220 may communicate an electronic “win message” to a client device, for example, client device 140a, in response to identifying the optimal bid and associated cloud environment march. The win message communicated by auction module 220 may be displayed graphically, textually, or not at all. The win message may trigger a connection between the client device associated with the winning bid and the associated matched cloud environment. For example, auction module 220 may determine that the optimal match is a bid associated with client device 140c and the qualified cloud environment associated with cloud environment 150b. Auction module 220 may communicate a message to client device 140c that establishes a connection with the resources of cloud environment 150b. In response to the connection established by auction module 220, cloud environment 150b may begin the job requested by client device 140c.

In various embodiments, before auction module 220 connects the winning client device and associated matched cloud environment via server 110 and network 160 auction module 220 may receive a job to perform along with the resource bid, for example, a requests for network access and data storage to perform the job of data mining, and auction module 220 may optimize the job and the matched cloud resources. For example, auction module 220 may grant client device 140a access to Servers S1, S2, and S7 (not shown) of cloud environment 150b.

It may be appreciated that the optimal match may be multiple cloud environments, for example, if Server A of cloud environment 150a and Server B of cloud environment 150b are optimal for resource bid 1 from client device 140b, auction module 220 may distribute access for client device 140b to Server A and Server B even though the aforementioned servers are located within different cloud environments.

In various embodiments, license module 230 may act generally to receive and store in memory licensing rules, laws, agreements from a plurality of entities and manages or checks for conflicts in license agreements between a client devise and a cloud environments, for example client device 140a and cloud environment 150c. License module 230 may receive license information from a client device or cloud environment via receiving module 200. License module 230 may use various techniques, for example, word search or natural language search, to identify conflicting language in received license agreements and communicate an electronic message to a client device or cloud environment associated with a conflict of received license information. In various embodiments, license module 230 may remove a bid or cloud environment from an auction, in response to received user input indicating a confirmation of licensing conflict.

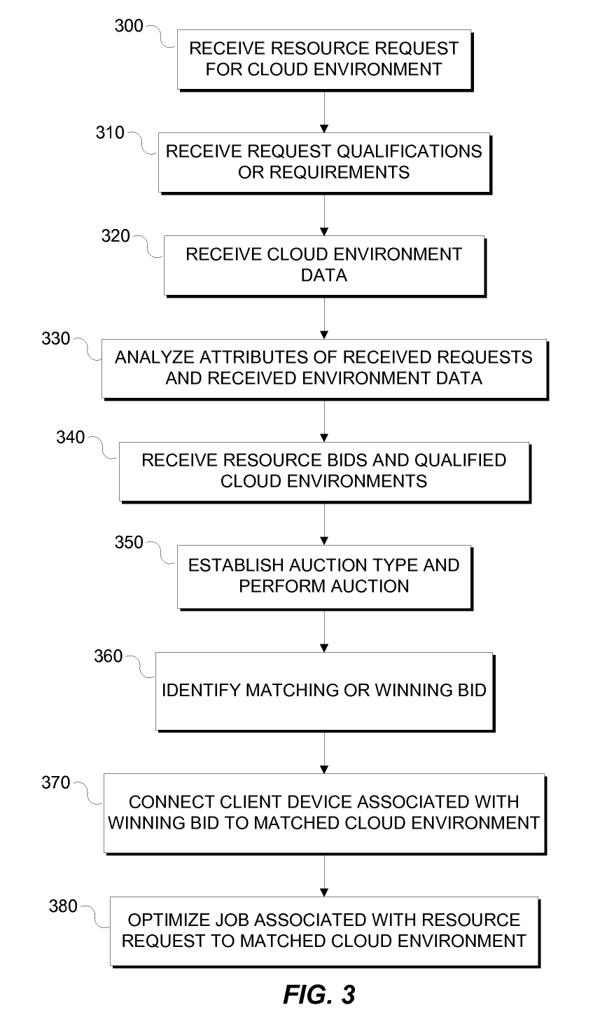

Referring to FIG. 3, a method according to an embodiment of the present invention for receiving and fulfilling requests for Cloud resources includes operational steps of auction application 111. The auction application 111 can be stored on a server computer, for example, server 110, within the data processing environment of FIG. 1. Now referring to FIGS. 1, 2, and 3, in step 300, receiving module 200 received resource requests for cloud environments from a user, for example, one of client devices 140. In step 310, receiving module 200 receives requests for resources with qualifications limiting resource requests. As described above, a request may identify specific attributes that are preferred for the requested cloud environment.

Receiving module 200 receives cloud environment data from any cloud environments 150 connected to auction application 111 via server 110 over network 160, in step 320. In step 330, receiving module 200 communicates received requests and received cloud environment data to matching module 210 where matching module 210 analyzes the attributes of received resource requests and received cloud environment data, identifying qualified cloud environments. In step 330, matching module 210 identifies qualified cloud environments based on analyzed received resource requests and received cloud environment data. Qualified cloud environments may be identified based on a preliminary match of cloud environments with received resource requests within a predefined range.

Auction module 220 receives bids from receiving module 200 and qualified cloud environments from matching module 210, in step 340, and analyzes attributes of received bids and qualified cloud environment. In step 350, auction module 220 determines the auction type to perform based on a predetermined selection, a random selection, or selection based on a multi-attribute auction algorithm, as described above. In various embodiments, auction module 220 may perform multiple instances of step 350 in parallel by performing one or more auction in parallel and determining the auction type based on which auction type that yields a match, times out, or delivers the best performance. Auction module 220 identifies the winning bid and associated cloud environment, in step 360, based on matching the requirements of a received bid, based on the resource request, with one or more qualified cloud environments, based on the MMP solution.

In step 370, auction module 220 establishes a connection between the client device associated with the winning bid and the associated qualified cloud environment. Auction module 220 optimizes the job associated with request in order to utilize the resources of the matched cloud environment efficiently, in step 380.

In various embodiments of the present invention, cloud environment providers may utilize auction application 111 to generate a secondary market for cloud resources. Bids for cloud environment resources may be received by auction application 111 from one or more cloud computing environments, for example, cloud environment 150a may request resources and be matched with cloud environment 150c, in the auction manner described above. It may be appreciated in the art that the secondary market environment may also include options, puts, and calls of cloud environments.

FIG. 4 depicts a block diagram of components of the computing devices distributed data processing environment 100 of FIG. 1, for example, server 110, in accordance with an embodiment of the present invention. It should be appreciated that FIG. 4 provides only an illustration of one implementation of one of the devices of FIG. 1 and does not imply any limitations with regard to the environments or devices in which different embodiments may be implemented. Many modifications to the depicted environment may be made.

Server 110 may include one or more processors 402, one or more computer-readable RAMs 404, one or more computer-readable ROMs 406, one or more computer readable storage media 408, device drivers 412, read/write drive or interface 414, network adapter or interface 416, all interconnected over a communications fabric 418. Communications fabric 418 may be implemented with any architecture designed for passing data and/or control information between processors (such as microprocessors, communications and network processors, etc.), system memory, peripheral devices, and any other hardware components within a system.

One or more operating systems 410, and one or more application programs 411, for example, auction application 111, are stored on one or more of the computer readable storage media 408 for execution by one or more of the processors 402 via one or more of the respective RAMs 404 (which typically include cache memory). In the illustrated embodiment, each of the computer readable storage media 408 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Server 110 may also include a R/W drive or interface 414 to read from and write to one or more portable computer readable storage media 426. Application programs 411 on server 110 may be stored on one or more of the portable computer readable storage media 426, read via the respective R/W drive or interface 414 and loaded into the respective computer readable storage media 408.

Server 110 may also include a network adapter or interface 416, such as a TCP/IP adapter card or wireless communication adapter (such as a 4G wireless communication adapter using OFDMA technology) for connection to a network 417. Application programs 411 on server 110 may be downloaded to the computing device from an external computer or external storage device via a network (for example, the Internet, a local area network or other wide area network or wireless network) and network adapter or interface 416. From the network adapter or interface 416, the programs may be loaded onto computer readable storage media 408. The network may comprise copper wires, optical fibers, wireless transmission, routers, firewalls, switches, gateway computers and/or edge servers.

Server 110 may also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 may comprise hardware and software (stored on computer readable storage media 408 and/or ROM 406).

Although, in the description above, various devices receive programming instructions or predetermined values from a user or developer, this is only meant to represent an example. Programming instructions and related data may also be generated by a computing device such that the programming instructions are received and execute on a computing device within distributed data processing environment 100 (FIG. 1).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows: On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows: Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows: Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 5, illustrative cloud computing environment 500 is depicted. As shown, cloud computing environment 500 comprises one or more cloud computing nodes 510 with which local computing devices used by cloud consumers, such as, for example, personal digital assistant (PDA) or cellular telephone 540A, desktop computer 540B, laptop computer 540C, and/or automobile computer system 540N may communicate. Computing nodes 510 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 540A-N shown in FIG. 5 are intended to be illustrative only and that computing nodes 510 and cloud computing environment 500 can communicate with any type of computerized device over any type of network and/or network addressable connection (e.g., using a web browser).

Referring now to FIG. 6, a set of functional abstraction layers provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 600 includes hardware and software components. Examples of hardware components include: mainframes 601; RISC (Reduced Instruction Set Computer) architecture based servers 602; servers 603; blade servers 604; storage devices 605; and networks and networking components 606. In some embodiments, software components include network application server software 607 and database software 608.

Virtualization layer 670 provides an abstraction layer from which the following examples of virtual entities may be provided: virtual servers 671; virtual storage 672; virtual networks 673, including virtual private networks; virtual applications and operating systems 674; and virtual clients 675.

In one example, management layer 680 may provide the functions described below. Resource provisioning 681 provides dynamic procurement of computing resources and other resources that are utilized to perform tasks within the cloud computing environment. Metering and Pricing 682 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 683 provides access to the cloud computing environment for consumers and system administrators. Service level management 684 provides cloud computing resource allocation and management such that required service levels are met. Service Level Agreement (SLA) planning and fulfillment 685 provide pre-arrangement for, and procurement of, cloud computing resources for which a future requirement is anticipated in accordance with an SLA.

Workloads layer 690 provides examples of functionality for which the cloud computing environment may be utilized. Examples of workloads and functions which may be provided from this layer include: mapping and navigation 691; software development and lifecycle management 692; virtual classroom education delivery 693; data analytics processing 694; transaction processing 695; and resource management processing 696.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

What is claimed is:

1. A computer implemented method for performing auctions of cloud based resources, the method comprising:
receiving a plurality of requests, wherein the request is for a set of cloud based resources;
receiving a set of preferences associated with the received plurality of requests;
receiving data associated with the set of cloud based resources, wherein the data includes an index of available resources, a cost value associated with one or more available resources of the index of available resources, and a rate of consumption value of available resources of the index of available resources;
establishing an auction technique for matching a subset of cloud based resources within the set of cloud based resources and an associated request of the plurality of requests; and
determining an match between a subset of cloud based resources and a received request, based on the received preferences and received data, wherein the match is an output of the established auction technique.

2. The method of claim 1, further comprising:
establishing a connection through a network between one or more cloud based resources in the matched set of cloud based resources and a computing device associated with the matched received request.

3. The method of claim 1, further comprising:
formatting a process associated with the matched received request based on the received data associated with the one or more cloud based resources of the matched set of cloud based resources.

4. The method of claim 1, wherein the received requests are associated with cloud resource providers.

5. The method of claim 1, wherein the cloud based resources include any of: computer resources, storage resources, network resources.

6. The method of claim 1, wherein the set of preferences includes: a list of jobs to be performed;
a priority value associated with one or more jobs of the list of jobs; and temporal data indicating a deadline for one or more jobs of the list of jobs.

7. The method of claim 1, wherein receiving a request further comprises: analyzing the received requests using natural language processing.

8. The method of claim 1, wherein the established auction technique is one or more of:
a first auction, wherein participants of the first auction are known, comprising:
establishing an initial price for one or more of the subset of cloud based resources; and
increasing the initial price based on a count, wherein the count is based on the received plurality of requests;
a second auction, wherein the participants are known, comprising:
establishing an initial price for one or more of the subset of cloud based resources; and
decreasing the initial price based on a count, wherein the count is based on the received plurality of requests;
a third auction comprising:
receiving a plurality of bids associated the received plurality of requests;
determining a winning bid in the plurality of bids, wherein the winning bid is a bid including a highest value; and
outputting a match based on the highest value bid; and
a fourth auction comprising:
receiving a plurality of bids associated the received plurality of requests;
determining a winning bid in the plurality of bids, wherein the winning bid is a bid including a highest value;
determining a second highest value, wherein the second highest value is less than the highest value; and
outputting a match based on the highest value bid, wherein the second highest value is paid.

9. The method of claim 1, wherein determining a match further includes matching one or more attributes of the request and cloud based resources, wherein attributes are a plurality of characteristics associated with the set of cloud based resources.

10. The method of claim 1, wherein the set of cloud based resources are provided by a plurality of cloud based environments.

11. A computer program product for performing auctions of cloud based resources, the computer program product comprising:
a computer-readable storage media having program instructions stored on the computer-readable storage media, the program instructions, executable by a device, comprising:
instructions to receive a plurality of requests, wherein the request is for a set of cloud based resources;
instructions to receive a set of preferences associated with the received plurality of requests;
instructions to receive data associated with the set of cloud based resources, wherein the data includes an index of available resources, a cost value associated with one or more available resources of the index of available resources, and a rate of consumption value of available resources of the index of available resources;
instructions to establish an auction technique for matching a subset of cloud based resources within the set of cloud based resources and an associated request of the plurality of requests; and
instructions to determine an match between a subset of cloud based resources and a received request, based on the received preferences and received data, wherein the match is an output of the established auction technique.

12. The computer program product of claim 11, further comprising:
instructions to establish a connection through a network between one or more cloud based resources in the matched set of cloud based resources and a computing device associated with the matched received request.

13. The computer program product of claim 11, further comprising:
instructions to format a process associated with the matched received request based on the received data associated with the one or more cloud based resources of the matched set of cloud based resources.

14. The computer program product of claim 11, wherein the cloud resources include any of:
computer resources, storage resources, network resources.

15. The computer program product of claim 11, wherein the set of preferences includes: a list of jobs to be performed; a priority value associated with one or more jobs of the list of jobs; and
temporal data indicating a deadline for one or more jobs of the list of jobs.

16. The computer program product of claim 11, wherein instructions to receive a request further comprises: instructions to analyze the received requests using natural language processing.

17. The computer program product of claim 11 wherein the established auction technique is one or more of:
a first auction, wherein participants of the first auction are known, comprising:
instructions to establish an initial price for one or more of the subset of cloud based resources; and
instructions to increase the initial price based on a count, wherein the count is based on the received plurality of requests;
a second auction, wherein the participants are known, comprising:
instructions to establish an initial price for one or more of the subset of cloud based resources; and
instructions to decrease the initial price based on a count, wherein the count is based on the received plurality of requests;
a third auction comprising:
instructions to receive a plurality of bids associated the received plurality of requests;
instructions to determine a winning bid in the plurality of bids, wherein the winning bid is a bid including a highest value; and
instructions to output a match based on the highest value bid; and
a fourth auction comprising:
instructions to receive a plurality of bids associated the received plurality of requests;
instructions to determine a winning bid in the plurality of bids, wherein the winning bid is a bid including a highest value;
instructions to determine a second highest value, wherein the second highest value is less than the highest value; and
instructions to output a match based on the highest value bid, wherein the second highest value is paid.

18. The computer program product of claim 11, wherein instructions to determine a match further includes instructions to match one or more attributes of the request and cloud based resources, wherein attributes are a plurality of characteristics associated with the set of cloud based resources.

19. The computer program product of claim 11, wherein the set of cloud based resources are provided by a plurality of cloud based environments.

20. A computer system for performing auctions of cloud based resources, the computer system comprising:
one or more computer processors;
one or more computer-readable storage media;
program instructions stored on the computer-readable storage media for execution by at least one of the one or more processors, the program instructions comprising:
instructions to receive a plurality of requests, wherein the request is for a set of cloud based resources;
instructions to receive a set of preferences associated with the received plurality of requests;
instructions to receive data associated with the set of cloud based resources, wherein the data includes an index of available resources, a cost value associated with one or more available resources of the index of available resources, and a rate of consumption value of available resources of the index of available resources;
instructions to establish an auction technique for matching a subset of cloud based resources within the set of cloud based resources and an associated request of the plurality of requests; and
instructions to determine an match between a subset of cloud based resources and a received request, based on the received preferences and received data, wherein the match is an output of the established auction technique.
